(19) United States
(12) Patent Application Publication
(10) Pub. No.: US 2013/0201956 A1
(43) Pub. Date: Aug. 8, 2013

(54) METHOD AND DEVICE FOR TRANSMITTING/RECEIVING DATA IN A MULTI RADIO ACCESS SYSTEM

(71) Applicants: Heejeong Cho, Anyang-si (KR); Eunjong Lee, Anyang-si (KR); Youngsoo Yuk, Anyang-si (KR); Jin Lee, Anyang-si (KR)

(72) Inventors: Heejeong Cho, Anyang-si (KR); Eunjong Lee, Anyang-si (KR); Youngsoo Yuk, Anyang-si (KR); Jin Lee, Anyang-si (KR)

(73) Assignee: LG ELECTRONICS INC., Seoul (KR)

(21) Appl. No.: 13/878,179

(22) PCT Filed: Oct. 5, 2011
(86) PCT No.: PCT/KR11/07338

§ 371 Date: Apr. 5, 2013

Related U.S. Application Data
(60) Provisional application No. 61/390,141, filed on Oct. 5, 2010.
(60) Provisional application No. 61/448,184, filed on Mar. 1, 2011.

(30) Foreign Application Priority Data
Oct. 4, 2011 (KR) 10-2011-0100659

(51) Int. Cl. H04W 72/04

(52) U.S. Cl. CPC H04W 72/048
USPC 370/329

(57) ABSTRACT

Provided is a method for performing communication by a user equipment (UE) supporting a multi-RAT, the method including transmitting a capability negotiation request message for Client Cooperation (CC) to a base station (BS); receiving a capability negotiation response message for CC from the BS; receiving an activation command message from CC including information on at least one candidate cooperative device; transmitting a connection message for CC to the at least one candidate cooperative device by using the information; and transmitting first data to the BS through at least one cooperative device, which is connected using the connection message, among the at least one candidate cooperative device. The first data is transmitted through a first radio access scheme between the UE and the at least one cooperative device, and is transmitted through a second radio access scheme between the at least one cooperative device and the BS.

### FIELD OF THE INVENTION

The present invention relates to wireless communication, and more particularly to a method and apparatus for transmitting/receiving data by a base station (BS) and a user equipment (UE) in a multi radio access system.

### BACKGROUND ART

In recent times, the amount of transmission data for use in a wireless communication network is rapidly increasing because various types of devices (such as a smart phone and a tablet PC) requesting Machine-to-Machine (M2M) communication and a large amount of transmission data have recently been developed and introduced to the market and have come into widespread use. In order to satisfy the requested high data transfer amount, not only carrier aggregation (CA) technology and cognitive radio technology for effective utilization of many more frequency bands, but also MIMO technology (Multiple Antennas technology) and multiple BS-cooperative transmission technology have recently been proposed and intensively researched.

In addition, with the introduction of Ubiquitous environment, the demand of users who desire to receive seamless services from anywhere at any time is rapidly increasing.

Therefore, a wireless communication network is being evolved in a manner that several UEs configure a mutual cooperative system and one or more UEs cooperate with each other according to a communication environment such that the UE(s) can transmit and receive data to and from the eNB.

In this case, several UEs include a source device, a cooperative device, and a candidate cooperative device. The source device is connected to other UEs in a wireless communication system, and communicates with a base station (BS) by receiving help from other UEs. The cooperative device serves as a relay for enabling the source device to communicate with the BS. The candidate cooperative device other than the source device does not serve as the cooperative device.

A wireless communication system including high-density UEs may have higher system performance by cooperation between UEs. For example, if a UE desires to transmit predetermined data to the BS, the source device can transmit the data along with the cooperative device having a superior communication quality. In addition, the source device does not participate in data transmission, and may transmit the data through the cooperative device having a superior communication quality. The above-mentioned example an be applied even in the case where the BS transmits data to the UE, resulting in superior system performance. The wireless communication system including a plurality of UEs constructing a cooperative system is referred to as a Multi Radio Access Technology (RAT) system.

### DETAILED DESCRIPTION OF THE INVENTION

### Technical Problem

Accordingly, the present invention is directed to wireless communication, and more particularly to a method and apparatus for transmitting/receiving data by a base station (BS) and a UE in a multi radio access system that substantially obviates one or more problems due to limitations and disadvantages of the related art.

An object of the present invention is to provide a method for enabling a UE supporting a Multi-RAT to communicate with another party.

Another object of the present invention is to provide a method for enabling a base station (BS) supporting a Multi-RAT to communicate with another party.

Another object of the present invention is to provide a user equipment (UE) for supporting a Multi-RAT.

Another object of the present invention is to provide a base station (BS) for supporting a Multi-RAT.

It is to be understood that technical objects to be achieved by the present invention are not limited to the aforementioned technical objects and other technical objects which are not mentioned herein will be apparent from the following description to one of ordinary skill in the art to which the present invention pertains.

### Technical Solution

The object of the present invention can be achieved by providing a method for performing communication by a user equipment (UE) supporting a multi-RAT (Multi-Radio Access Technology), the method including: transmitting a capability negotiation request message for a client cooperation (CC) to a base station (BS); receiving a capability negotiation response message for the CC from the base station (BS); receiving an activation command message for the CC including information regarding at least one candidate cooperative device from the base station (BS); transmitting a connection message for the CC to the at least one candidate cooperative device using information regarding the at least one candidate cooperative device; and transmitting a first data to the base station (BS) using at least one cooperative device connected through the connection message from among the at least one candidate cooperative device, wherein the first data is communicated between the UE and the at least one cooperative device using a first radio access scheme, and is communicated between the at least one cooperative device and the base station (BS) using a second radio access scheme.

The method may further include: directly transmitting a second data to the base station (BS) using the second radio access scheme.

The first radio access scheme may be a Wireless Fidelity (WiFi) access scheme, and the second radio access scheme may be a Worldwide Interoperability for Microwave Access (WiMAX) access scheme.

The capability negotiation request message may include a request for at least one of connection RAT type information, system type information, system version information, location information, and information regarding availability of role performance of the cooperative device by the UE.

The method may further include: after receiving the capability negotiation response message, transmitting a first activation request message for the CC including location information of the UE to the base station (BS); and receiving the activation command message from the base station (BS) in response to the first activation request message.

The method may further include: after receiving the capability negotiation response message, receiving a first activation request message for the CC from the base station (BS); and transmitting a first activation response message for the CC including location information of the UE to the base station (BS), wherein the activation command message is received from the base station (BS) in response to the first activation response message.

In another aspect of the present invention, a method for performing communication by a base station (BS) supporting a multi-RAT (Multi-Radio Access Technology) includes: receiving a capability negotiation request message for a client cooperation (CC) from a user equipment (UE); transmitting a capability negotiation response message for the CC to the user equipment (UE); transmitting an activation command message for the CC including information regarding at least one candidate cooperative device to the user equipment (UE); and receiving a first data using at least one cooperative device connected to the UE through a connection message for the CC from among the at least one candidate cooperative device, wherein the first data is communicated between the UE and the at least one cooperative device using a first radio access scheme, and is communicated between the at least one cooperative device and the base station (BS) using a second radio access scheme.

The method may further include: directly receiving a second data from the user equipment (UE) using the second radio access scheme.

The first radio access scheme may be a Wireless Fidelity (WiFi) access scheme, and the second radio access scheme may be a Worldwide Interoperability for Microwave Access (WiMAX) access scheme.

The capability negotiation request message may include a request for at least one of connection RAT type information, system type information, system version information, location information, and information regarding availability of role performance of the cooperative device by the UE.

The method may further include: after transmitting the capability negotiation response message, receiving a first activation request message for the CC including location information of the UE from the UE; transmitting a second activation request message for the CC to the at least one candidate cooperative device using the location information of the UE; and receiving a second activation response message for the CC from the at least one candidate cooperative device, wherein the activation command message is transmitted to the UE using the received second activation response message.

The method may further include: after transmitting the capability negotiation response message, transmitting a first activation request message for the CC to the UE; receiving a first activation response message for the CC including location information of the UE from the UE; and transmitting a second activation request message for the CC to the at least one candidate cooperative device using the location information; and receiving a second activation response message for the CC from the at least one candidate cooperative device, wherein the activation command message is transmitted to the UE using the received second activation response message.

In another aspect of the present invention, a method for performing communication by a user equipment (UE) supporting a multi-RAT (Multi-Radio Access Technology) to includes: transmitting a capability negotiation request message for a client cooperation (CC) to a base station (BS), the capability negotiation request message including location information of the UE and an activation request indicator for the CC; receiving a capability negotiation response message for the CC including information regarding at least one candidate cooperative device from the base station (BS); transmitting a connection message for the CC to the at least one candidate cooperative device using information regarding the at least one candidate cooperative device; and transmitting a first data to the base station (BS) using at least one cooperative device connected through the connection message from among the at least one candidate cooperative device, wherein the first data is communicated between the UE and the at least one cooperative device using a first radio access scheme, and is communicated between the at least one cooperative device and the base station (BS) using a second radio access scheme.

In another aspect of the present invention, a method for performing communication by a base station (BS) supporting a multi-RAT (Multi-Radio Access Technology) includes: receiving a capability negotiation request message for a client cooperation (CC) from a user equipment (UE), the capability negotiation request message including location information of the UE and an activation request indicator for the CC; transmitting a second activation request message for the CC to the at least one candidate cooperative device using the location information of the UE; receiving a second activation response message for the CC from the at least one candidate cooperative device; transmitting a capability negotiation response message for the CC including information of the at least one candidate cooperative device to the UE using the received second activation response message; receiving a first data using at least one cooperative device connected to the UE through the connection message for the CC from among the at least one candidate cooperative device, wherein the first data is communicated between the UE and the at least one cooperative device using a first radio access scheme, and is communicated between the at least one cooperative device and the base station (BS) using a second radio access scheme.

In another aspect of the present invention, a method for performing communication by a user equipment (UE) supporting a multi-RAT (Multi-Radio Access Technology) includes: transmitting a capability negotiation request message for a client cooperation (CC) including location information of the UE to a base station (BS); receiving a capability negotiation response message for the CC from the base station (BS), the capability negotiation response message including an activation request indicator for the CC and information regarding at least one candidate cooperative device; transmitting a connection message for the CC to the at least one candidate cooperative device using information regarding the at least one candidate cooperative device; and transmitting a first data to the base station (BS) using at least one cooperative device connected through the connection message from among the at least one candidate cooperative device, wherein the first data is communicated between the UE and the at least one cooperative device using a first radio access scheme, and is communicated between the at least one cooperative device and the base station (BS) using a second radio access scheme.

In another aspect of the present invention, a method for performing communication by a base station (BS) supporting a multi-RAT (Multi-Radio Access Technology) includes: receiving a capability negotiation request message for a client cooperation (CC) including location information of a user equipment (UE) from the user equipment (UE); transmitting a second activation request message for the CC to the at least one candidate cooperative device using the location information of the UE; receiving a second activation response message for the CC from the at least one candidate cooperative device; transmitting a capability negotiation response message for the CC, including information of the at least one candidate cooperative device and an activation request indicator for the CC, to the UE using the received second activation response message; and receiving a first data using at least one cooperative device connected to the UE through the connection message for the CC from among the at least one candidate cooperative device, wherein the first data is communicated between the UE and the at least one cooperative device using a first radio access scheme, and is communicated between the at least one cooperative device and the base station (BS) using a second radio access scheme.

In another aspect of the present invention, a user equipment (UE) for supporting a multi-RAT (Multi-Radio Access Technology) includes: a transmission (Tx) module for transmitting a capability negotiation request message for a client cooperation (CC) to a base station (BS), and transmitting a connection message for the CC to the at least one candidate cooperative device using information regarding the at least one candidate cooperative device; a reception (Rx) module for receiving a capability negotiation response message for the CC from the base station (BS), and receiving an activation command message for CC including information regarding the at least one candidate cooperative device from the base station (BS); and a processor for transmitting a first data to the base station (BS) using at least one cooperative device connected through the connection message from among the at least one candidate cooperative device, controlling the first data to be communicated between the UE and the at least one cooperative device using a first radio access scheme and controlling the first data to be communicated between the at least one cooperative device and the base station (BS) using a second radio access scheme.

In another aspect of the present invention, a base station (BS) for supporting a multi-RAT (Multi-Radio Access Technology) includes: a reception (Rx) module for receiving a capability negotiation request message for a client cooperation (CC) from a user equipment (UE), and receiving a first data using at least one cooperative device connected to the UE through the connection message for the CC from among the at least one candidate cooperative device; a transmission (Tx) module for transmitting a capability negotiation response message for the CC to the user equipment (UE), and transmitting an activation command message for the CC including specific information regarding the at least one candidate cooperative device to the user equipment (UE); and a processor for controlling the first data to be communicated between the UE and the at least one cooperative device using a first radio access scheme, and controlling the first data to be communicated between the at least one cooperative device and the base station (BS) using a second radio access scheme.

In another aspect of the present invention, a user equipment (UE) for supporting a multi-RAT (Multi-Radio Access Technology) includes: a transmission (Tx) module for transmitting a capability negotiation request message for a client cooperation (CC) to a base station (BS), the capability negotiation request message including location information of the UE and an activation request indicator for the CC, and transmitting a connection message for the CC to the at least one candidate cooperative device using information regarding the at least one candidate cooperative device; a reception (RX) module for receiving a capability negotiation response message for the CC including specific information regarding the at least one candidate cooperative device from the base station (BS); and a processor for transmitting a first data to the base station (BS) using at least one cooperative device connected through the connection message from among the at least one candidate cooperative device, controlling the first data to be communicated between the UE and the at least one cooperative device using a first radio access scheme and controlling the first data to be communicated between the at least one cooperative device and the base station (BS) using a second radio access scheme.

In another aspect of the present invention, a user equipment (UE) for supporting a multi-RAT (Multi-Radio Access Technology) includes: a transmission (Tx) module for transmitting a capability negotiation request message for a client cooperation (CC) including location information of the UE to a base station (BS), and transmitting a connection message for the CC to the at least one candidate cooperative device using information regarding the at least one candidate cooperative device; a reception (Rx) module for receiving a capability negotiation response message for the CC from the base station (BS), the capability negotiation response message including an activation request indicator for the CC and information regarding the at least one candidate cooperative device; and a processor for transmitting a first data to the base station (BS) using at least one cooperative device connected through the connection message from among the at least one candidate cooperative device, controlling the first data to be communicated between the UE and the at least one cooperative device using a first radio access scheme and controlling to be communicated between the at least one cooperative device and the base station (BS) using a second radio access scheme.

### Effects of the Invention

As is apparent from the above description, the BS for use in the multi-RAT system can effectively transmit data to a source device according to embodiments of the present invention. In addition, the source device for use in the multi-RAT system can effectively transmit data to the BS through the cooperative device according to embodiments of the present invention.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

### BRIEF DESCRIPTION OF THE DRAWINGS

FIG. 1 is a conceptual diagram illustrating a multi-RAT system according to an embodiment of the present invention.

FIG. 2 is a conceptual diagram illustrating operations of the multi-RAT system.

FIG. 3 exemplarily shows a Frequency Division Duplex (FDD) radio frame structure for use in 3GPP LTE.

FIG. 4 exemplarily shows a Time Division Duplex (TDD) radio frame structure for use in 3GPP LTE.

FIG. 5 exemplarily shows a resource grid of a downlink slot.

FIG. 6 is a downlink (DL) subframe structure.

FIG. 7 is an uplink (UL) subframe structure for use in LTE system.

FIG. 8 is a conceptual diagram illustrating the mapping relationship among codewords, layers and antennas for transmitting a downlink signal in a MIMO wireless communication system.

FIG. 9 is a flowchart illustrating an information exchange stage required for transmitting/receiving data between the BS and a plurality of UEs in a multi-RAT system.

FIG. 10 is a flowchart illustrating a general network entry stage for use in a multi-RAT system according to an embodiment of the present invention.

FIG. 11 is a flowchart illustrating an exemplary negotiation stage for cooperation of a plurality of devices in a multi-RAT system according to an embodiment of the present invention.

FIG. 12 is a flowchart illustrating an exemplary negotiation stage required when a source device transmits information requesting assistance of a cooperative device in a multi-RAT system.

FIG. 13 is a flowchart illustrating an exemplary negotiation stage required when a base station (BS) transmits information requesting assistance of a cooperative device in a multi-RAT system.

FIG. 14 is a flowchart illustrating another exemplary negotiation stage required when a base station (BS) transmits information requesting assistance of a cooperative device in a multi-RAT system.

FIG. 15 is a flowchart illustrating a method for searching for a neighbor device of a source device and selecting a cooperative device from among retrieved neighbor devices.

FIG. 16 is a flowchart illustrating another method for searching for a neighbor device of a source device and selecting a cooperative device from among retrieved neighbor devices.

FIG. 17 is a flowchart illustrating an example of connection to the selected cooperative device according to an embodiment of the present invention.

FIG. 18 is a flowchart illustrating another example of connection to the selected cooperative device according to an embodiment of the present invention.

FIG. 19 is a block diagram illustrating a base station (BS) and a user equipment (UE) according to embodiments of the present invention.

### BEST MODE FOR CARRYING OUT THE INVENTION

The following embodiments of the present invention can be applied to a variety of multiple access schemes, for example, CDMA (Code Division Multiple Access), FDMA (Frequency Division Multiple Access), TDMA (Time Division Multiple Access), OFDMA (Orthogonal Frequency Division Multiple Access), SC-FDMA (Single Carrier Frequency Division Multiple Access), and the like. CDMA may be embodied with wireless (or radio) technology such as UTRA (Universal Terrestrial Radio Access) or CDMA2000. TDMA may be embodied with wireless (or radio) technology such as GSM (Global System for Mobile communications)/GPRS (General Packet Radio Service)/EDGE (Enhanced Data Rates for GSM Evolution). OFDMA may be embodied with wireless (or radio) technology such as Institute of Electrical and Electronics Engineers (IEEE) 802.11 (Wi-Fi), IEEE 802.16 (WiMAX), IEEE 802-20, and E-UTRA (Evolved UTRA). UTRA is a part of UMTS (Universal Mobile Telecommunications System). 3GPP (3rd Generation Partnership Project) LTE (long term evolution) is a part of E-UMTS (Evolved UMTS), which uses E-UTRA. 3GPP LTE employs OFDMA in downlink and employs SC-FDMA in uplink. LTE-Advanced (LTE-A) is an evolved version of 3GPP LTE. IEEE 802.16m is an evolved version of IEEE 802.16e.

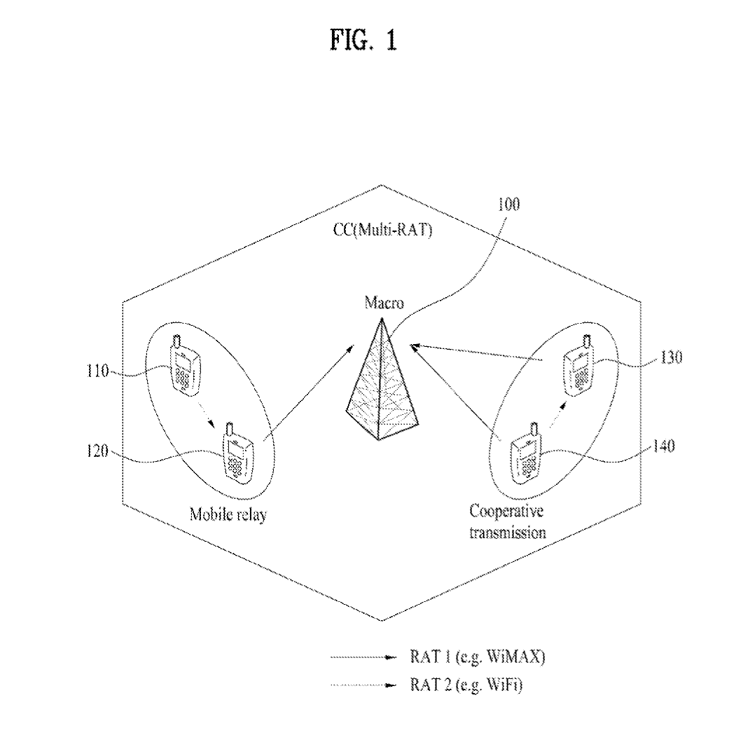

FIG. 1 is a conceptual diagram illustrating a multi-RAT system according to an embodiment of the present invention.

Referring to FIG. 1, the multi-RAT system includes a base station (BS) 100 and a plurality of communication devices 110, 120, 130 and 140.

Each communication device (110, 120, 130 or 140) may be any one of a source device, a cooperative device, and a candidate cooperative device. In more detail, the source device is connected to other UEs, and communicates with a base station (BS) by receiving help from other UEs. The cooperative device serves as a relay for enabling the source device to communicate with the BS. The candidate cooperative device other than the source device does not serve as the cooperative device.

In the multi-RAT system, several communication devices (110, 120, 130, 140) may construct a cooperative system. In the multi-RAT system constructing the cooperative system, the source device can transmit data to the BS along with the cooperative device having a superior communication quality. The source device may also receive data from the BS along with the cooperative device having a superior communication quality.

Referring to FIG. 1, the source device 140 for use in the multi-RAT system constructing the cooperative system can transmit data to the BS 100 along with the cooperative device 130 having a superior communication quality. The communication device can efficiently transmit data such that it can guarantee superior performance.

In addition, the source device in the multi-RAT system constructing the cooperative system does not participate in data transmission, and can transmit data to the BS through a cooperative device having a superior communication quality. Furthermore, the source device does not participate in data reception, and can receive data from the BS through the cooperative device having a superior communication quality.

Referring to FIG. 1, the source device in the multi-RAT system constructing the cooperative system does not participate in data transmission, and can transmit data to the BS 100 through the cooperative device 120 having superior communication quality. As a result, the communication device can efficiently transmit data so that it can prevent deterioration of system performance.

Although FIG. 1 shows an example in which the source device transmits data to the BS through the cooperative device, it should be noted that the above-mentioned contents may also be applied to the case in which the BS receives data from the source device,

In addition, when another data is transmitted, the source device 110 or 140 of FIG. 1 may be a cooperative device or a neighbor device which does not participate in data transmission. The cooperative device 120 or 130 may be a source device or a neighbor device which does not participate in data transmission.

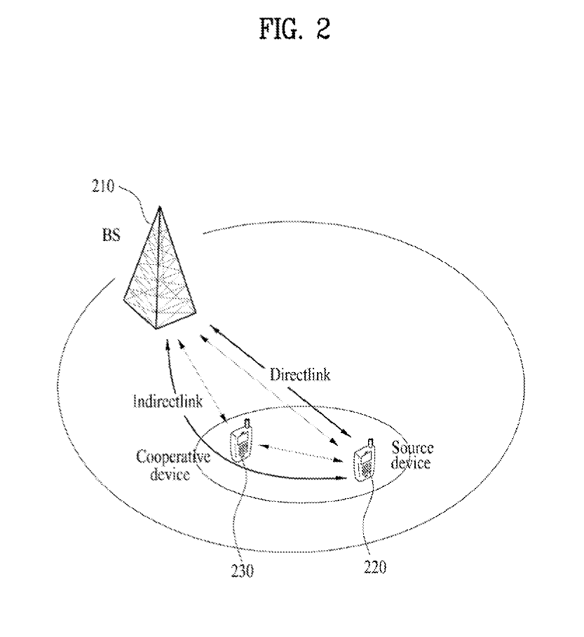

FIG. 2 is a conceptual diagram illustrating operations of the multi-RAT system.

Referring to FIG. 2, the multi-RAT system includes a base station (BS) 210 and a plurality of communication devices 220 and 230.

In the multi-RAT system, several communication devices 220 and 230 may construct a cooperative system through a wireless technology such as 802.11 (Wi-Fi).

Generally, each communication device 220 or 2230 may directly transmit or receive data to and from the BS 210 through a wireless technology such as IEEE 802.16 (WiMAX).

In this case, if a current communication quality of the source device 220 is abruptly decreased, the source device 220 does not participate in data transmission and may indirectly transmit data to the BS 210 through the cooperative device 230 having a superior communication quality.

Therefore, the communication device for use in the multi-RAT system may directly communicate with the BS and may also indirectly communicate with the BS upon receiving assistance of the cooperative device, such that it can prevent deterioration of system performance and can perform efficient data communication.

In order to enable a plurality of communication device to cooperate with each other for data transmission/reception in the multi-RAT system, a previous procedure for selectively exchanging information is needed.

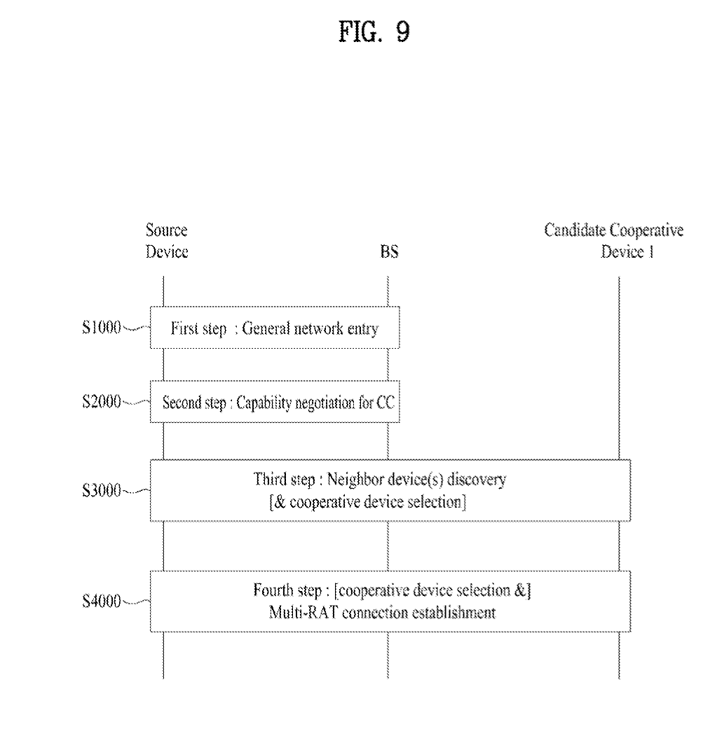

An information exchange stage to be performed between the BS and the communication devices in the multi-RAT system can be largely classified into four steps, i.e., a general network entry stage, a negotiation stage for cooperation of several devices, a stage for searching for a neighbor device of a source device and selecting a neighbor device from among the retrieved neighbor devices, and a stage for connecting to the selected cooperative device. A detailed description thereof will be described later with reference to FIGS. 9 to 18.

Next, the structure of the radio frame to which the present invention is applicable will be described.

Although the structure of the radio frame applied in 3GPP LTE is described for convenience of description, the scope or spirit of the present invention is not limited thereto and can also be applied to various types of radio frames.

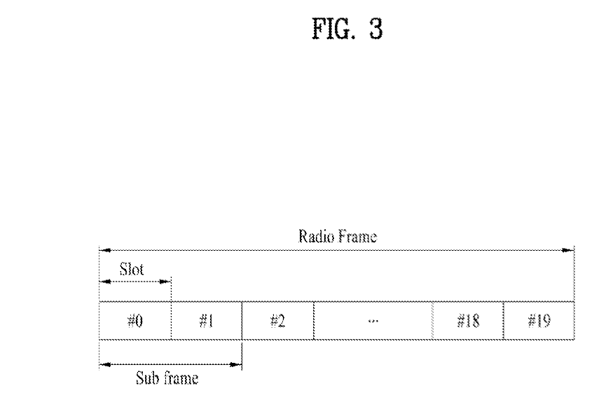

FIG. 3 is a diagram showing the structure of a frequency division duplex (FDD) radio frame in 3^{rd} generation partnership project (3GPP) long term evolution (LTE). Such a radio frame is referred to as frame structure type 1.

Referring to FIG. 3, the radio frame includes 10 subframes and one subframe includes 2 contiguous slots. A time required for transmitting one subframe is defined as a transmission time interval (TTI). The duration of the radio frame is T_{f}=307200*Tₛ=10 ms and includes 20 slots. The duration of each slot is Tₛₗₒₜ=15360*Tₛ=0.5 ms and the 20 slots are numbered 0 to 19. Downlink, in which each node or base station (BS) transmits a signal to the UE, and uplink, in which the UE transmits a signal to each node or base station (BS), are distinguished in a frequency domain.

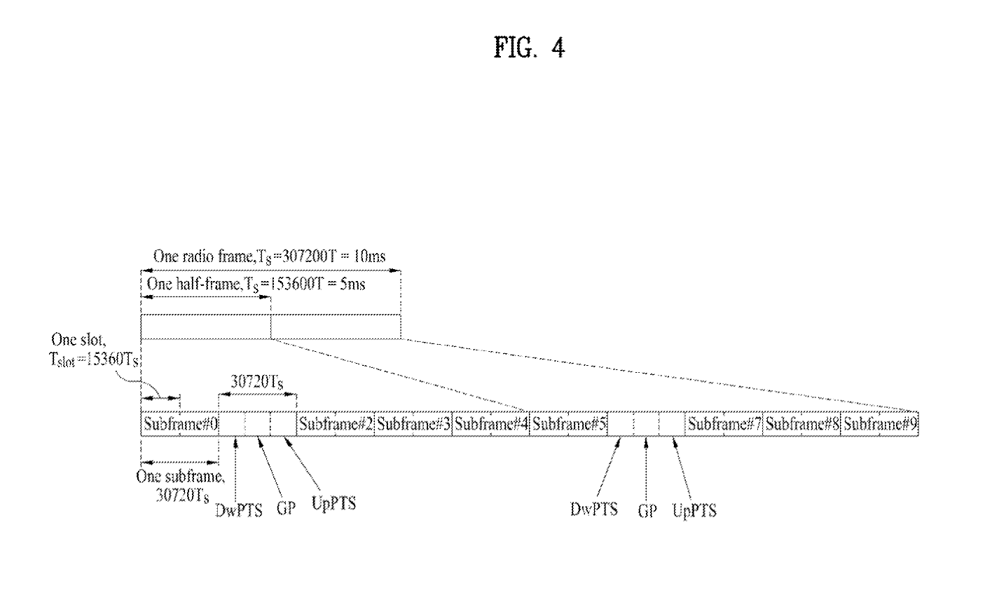

FIG. 4 is a diagram showing the structure of a time division duplex (TDD) radio frame in 3GPP LTE. Such a radio frame structure is referred to as frame structure type 2.

Referring to FIG. 4, one radio frame has a length of 10 ms and includes two half-frames each having a length of 5 ms. In addition, one half-frame includes 5 subframes each having a length of 1 ms. One subframe is set to any one of an uplink (UL) subframe, a downlink (DL) subframe and a special subframe. One radio frame includes at least one uplink subframe and at least downlink subframe. One subframe is defined as two continuous slots. For example, the length of one subframe may be 1 ms and the length of one slot may be 0.5 ms.

The special subframe is a specific period for dividing uplink and downlink between an uplink subframe and a downlink subframe. One radio frame includes at least one special subframe and the special subframe includes a downlink pilot time slot (DwPTS), a guard period, and an uplink pilot time slot (UpPTS). DwPTS is used to perform initial cell search, synchronization or channel estimation. The UpPTS is used to perform channel estimation in a base station and uplink transmission synchronization of a terminal. The guard period is used to eliminate interference occurring in uplink due to multi-path delay of a downlink signal between uplink and downlink.

In the FDD and TDD radio frames, one slot includes a plurality of orthogonal frequency division multiplexing (OFDM) symbols in a time domain and includes a plurality of resource blocks (RBs) in a frequency domain. An OFDM symbol represents one symbol period because 3GPP LTE uses OFDMA in downlink and may be called SC-FDMA symbol. The resource block is a resource assignment unit and includes a plurality of contiguous subcarriers per slot.

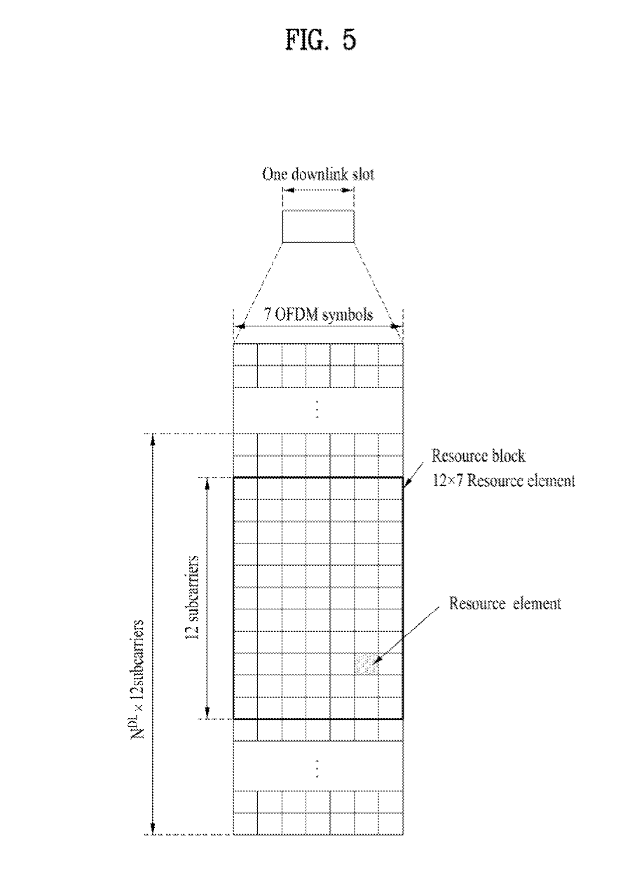

For the structure of the radio frame described with reference to FIGS. 4 and 5, refer to Chapters 4.1 and 4.2 of 3GPP TS 36.211 V8.3.0 (2008-05) “Technical Specification Group Radio Access network; Evolved Universal Terrestrial Radio Access (E-UTRA); Physical Channels and Modulation (Release 8)”.

The above-described structure of the radio frame is only exemplary and the number of subframes included in the radio frame, the number of slots included in the subframe and the number of OFDM symbols included in the slot may be changed in various ways.

FIG. 5 is a diagram showing an example of resource grid of one downlink slot.

Referring to FIG. 5, one downlink slot includes a plurality of OFDM symbols in a time domain. Although one downlink slot includes 7 OFDMA symbols and one RB includes 12 subcarriers in the frequency domain in the above-described example, the scope or spirit of the present invention is not limited thereto.

Each element on the resource grid is referred to as a resource element and one RB includes 12×7 resource elements. The number N^{DL} of RBs included in a downlink slot depends on downlink transmission bandwidth. The resource grid of the downlink slot is applicable to an uplink slot.

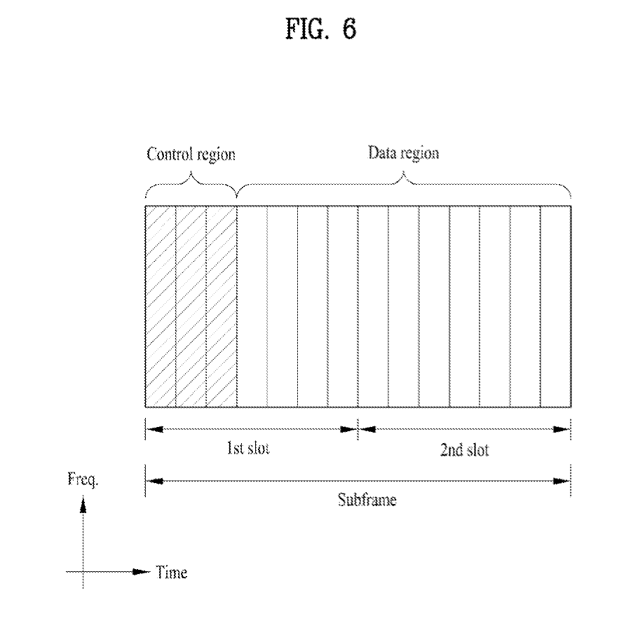

FIG. 6 is a diagram showing an example of a downlink subframe structure.

Referring to FIG. 6, a subframe includes two contiguous slots. At most first three OFDM symbols of a first slot in a subframe correspond to a control region to which downlink control channels are assigned and the remaining OFDM symbols correspond to a data region to which physical downlink shared channels (PDSCHs) are assigned.

A downlink control channel includes a physical control format indicator channel (PCFICH), a physical downlink control channel (PDCCH), a physical hybrid-ARQ indicator channel (PHICH), etc. A PCFICH transmitted at a first OFDM symbol of a subframe carries information about the number of OFDM symbols (that is, the size of the control region) used to transmit control channels within a subframe. Control information transmitted through a PDCCH is referred to as downlink control information (DCI). The DCI indicates uplink resource assignment information, downlink resource assignment information and uplink transmit power control command of arbitrary UE groups. The PHICH carries an acknowledgement (ACK)/negative-acknowledgement (NACK) signal of a hybrid automatic repeat request (HARQ) of uplink data. That is, the ACK/NACK signal of the uplink data transmitted by the UE is transmitted via the PHICH.

The PDSCH is a channel for transmitting control information and/or data. The terminal may decode downlink control information transmitted via a PDCCH and read data transmitted through a PDSCH.

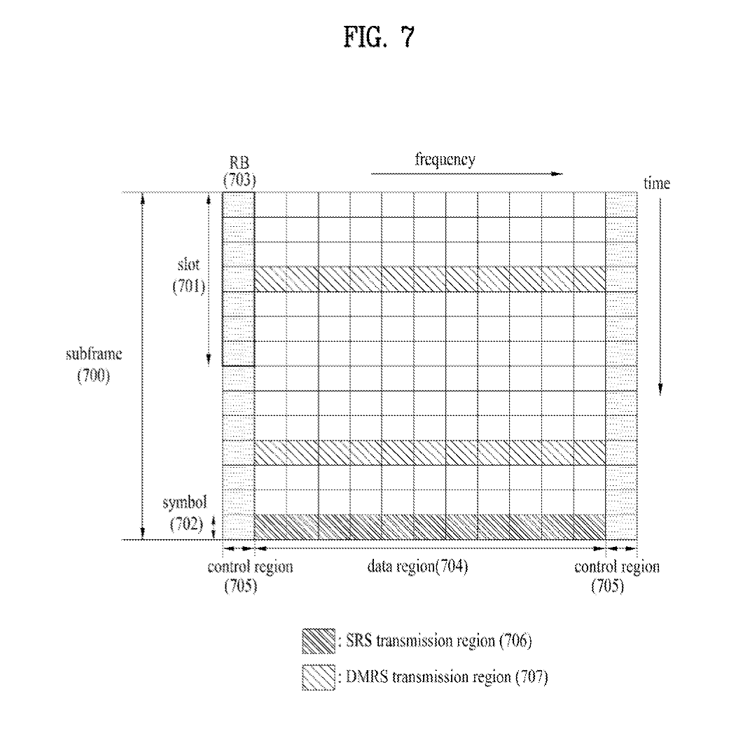

FIG. 7 is a diagram showing the structure of an uplink subframe used in an LTE system.

Referring to FIG. 7, a 1 ms subframe 700, which is a basic unit of LTE uplink transmission, consists of two 0.5 ms slots 701. When assuming a length of a normal Cyclic Prefix (CP), each slot consists of 7 symbols 702 and one symbol corresponds to one SC-FDMA symbol. A resource block 703 is a resource allocation unit corresponding to 12 subcarriers in a frequency domain and one slot in a time domain. The structure of the uplink subframe of the LTE system is broadly divided into a data region 704 and a control region 705. The data region refers to a series of communication resources used upon transmitting data such as voice and packets transmitted to each UE and corresponds to resources except for the control region within the subframe. The control region refers to a series of communication resources used upon transmitting a downlink channel quality report received from each UE, a downlink ACK/NACK signal, and an uplink scheduling request.

As shown in FIG. 7, a region 706 where a Sounding Reference Signal (SRS) can be transmitted within one subframe is an interval where the last SC-FDMA symbol is located on a time domain within one subframe and the SRS is transmitted through a data transmission band on a frequency domain. SRSs of several UEs transmitted through the last SC-FDMA symbol of the same subframe may be distinguished by a cyclic shift value. Regions where a Demodulation Reference Signal (DMRS) is transmitted within one subframe are intervals where a middle SC-FDMA symbol within one slot, that is, the fourth SC-FDMA symbol and the eleventh SC-FDMA symbol are located. The DMRS is transmitted through the data transmission band on a frequency domain.

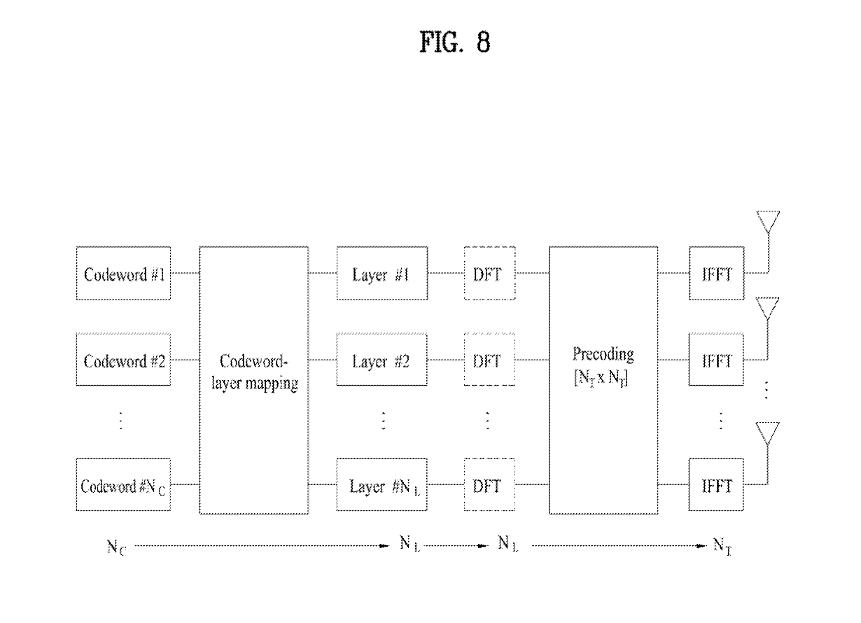

FIG. 8 is a diagram explaining a mapping relationship among codewords, layers, and antennas for transmitting a downlink signal in a MIMO wireless communication system.

Referring to FIG. 8, a complicated mapping relationship exists between data information and transmission symbols. A MAC layer as data information transmits N_{c} transport blocks to a physical layer. In the physical layer, the transport blocks are converted into codewords through a channel coding process and rate matching such as a puncturing or repetition process is performed. In this case, channel coding is performed in a channel coder such as a turbo encoder or a tail bit convolution encoder.

After the channel coding and rate matching processes, N_{c} codewords are mapped to N_{L} layers. A layer refers to each of different pieces of information transmitted using MIMO technology. The number of layers cannot be greater than a rank which is a maximum number capable of transmitting different pieces of information.

For reference, unlike OFDMA transmission which is a general downlink transmission scheme, an uplink signal transmitted according to an SC-FDMA scheme is subject to a DFT process with respect to each layer so that a transmission signal has properties of a single subcarrier by partially offsetting an influence of Inverse Fast Fourier Transform (IFFT) processing.

DFT-converted signals in each layer are multiplied by a precoding matrix, mapped to N_{T} transmission antennas, and transmitted to a BS through an IFFT process.

Generally, a downlink RS includes a common RS and a UE specific RS. Precoding is not applied to the common RS. Meanwhile, the UE specific RS is inserted into a previous stage of the precoding in the same way as general data and is precoded. The precoded UE specific RS is then transmitted to a UE.

In order to implement channel non-dependence spatial multiplexing transmission using the UE specific RS (i.e., a dedicated RS), some limitation conditions may exist. First, in order to reduce signaling overhead of the reference signal (RS), the transmission RS must be precoded using the same precoding matrix as the modulated data symbol. In addition, in order to obtain the spatial channel diversity, the precoding matrix must be switched between antennas. However, the dedicated RS is transmitted regularly or arbitrarily throughout the entire transmission resource region, such that it is difficult to satisfy the above-mentioned limitation. In more detail, channel measurement is achieved in units of a predetermined number of resource elements (REs) for efficient channel measurement, such that it is impossible for the precoding matrix for precoding the dedicated RS to be changed in units of a resource element (RE).

Meanwhile, in order to enable a plurality of communication devices in the multi-RAT system to cooperate with each other for data transmission/reception, a previous stage for selectively exchanging information is needed.

In each stage of the above-mentioned information exchange procedure, individual communication devices may be located in three states, that is, a first state in which communication devices are not connected to each other, a second state in which one communication device recognizes and authenticates another communication device, and a third state in which one communication device is connected to another communication device.

Detailed description of the first state, the second state, and the third state will be given below with reference to Table 1.

TABLE 1

| | Authentication | Association |
|---|---|---|
| State 1 | X | X |
| State 2 | ◯ | X |
| State 3 | ◯ | ◯ |

The first state indicates a specific state in which several communication devices are not connected to each other in the multi-RAT system. Therefore, individual source devices must directly communicate with the BS in the first state.

The second state indicates a specific state in which one communication device obtains information of the counterpart communication device and authenticates information of the counterpart communication device.

Various methods for obtaining information of the counterpart communication device may be used, for example, a passive method for receiving information regarding the counterpart communication device through a beacon message, and an active method for transmitting a probe request message and receiving information of the counterpart communication device through the received probe response message as a response of the transmitted probe request message.

Individual communication devices obtain information of the counterpart communication devices using the above-mentioned method, and exchange authentication frames (for example, an authentication request and an authentication response) with the counterpart communication device so that an authentication confirmation process is completed.

If the authentication confirmation process is completed, each communication device enters the second state.

Finally, the third state indicates a specific state in which one communication device is connected to the authenticated counterpart communication device.

That is, each communication device exchanges association frames (for example, an association request and an association response) with the counterpart communication device, such that the association process (for example, AID allocation) is completed. If the association process of several communication devices is completed in the multi-RAT system, data communication can be achieved between the above-mentioned communication devices.

The above-mentioned description has disclosed states of communication devices in each stage of the information exchange procedure. For better understanding of the present invention, individual stages of the information exchange procedure in the radio access system including the base station (BS) will hereinafter be described in detail.

The information exchange step to be performed between the BS and the communication devices in the multi-RAT system is largely classified into four steps, that is, a general network entry step, a negotiation step for cooperation of several devices, a step for searching for a neighbor device of a source device and selecting a cooperative device from among the retrieved neighbor devices, and a step for connection to the selected cooperative device.

For convenience of description and better understanding of the present invention, it is assumed that the entity of each step of the information exchange procedure is a source device. However, the scope or spirit of the present invention is not limited thereto, and can also be applied to a device for supporting the multi-RAT system, a cooperative device, and a candidate cooperative device in each step.

FIG. 9 is a flowchart illustrating an information exchange stage required for transmitting/receiving data between the BS and a plurality of UEs in a multi-RAT system.

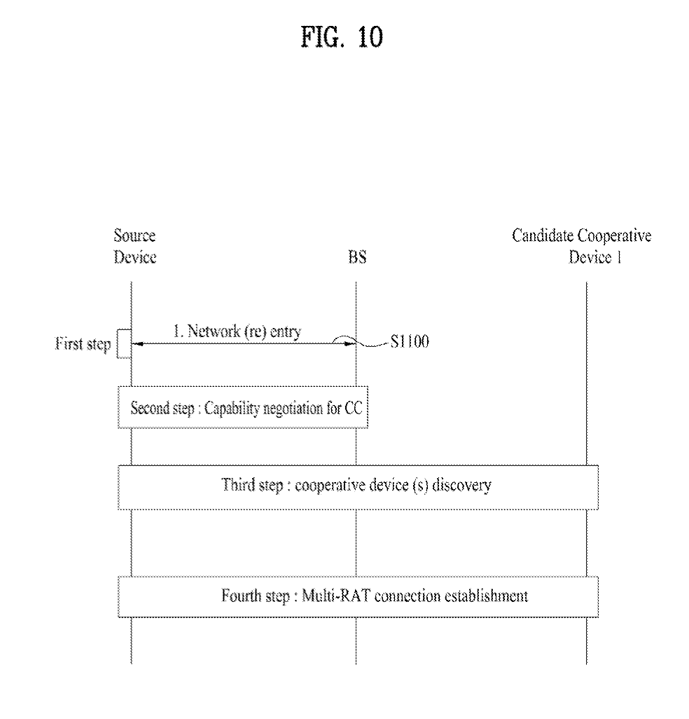

Referring to FIG. 9, a source device enters a general network entry step S1000 with the BS. That is, the source device is connected to the BS through the general network entry step S1000 such that it can directly transmit and receive data to and from the BS. For convenience of description, the general network entry step S1000 will hereinafter be referred to as a first step. A detailed description of the first step will hereinafter be described with reference to FIG. 10.

The source device passing through the first step through the BS is configured to enter the negotiation step S2000 for cooperation of several devices in the multi-RAT system. In the negotiation step S2000, the source device negotiates with the BS about capability for cooperation operation.

In this case, transmission/reception information between the BS and the source device may include connection RAT type information, system type information, system version information, location information, and information regarding execution or non-execution of the cooperative device role.

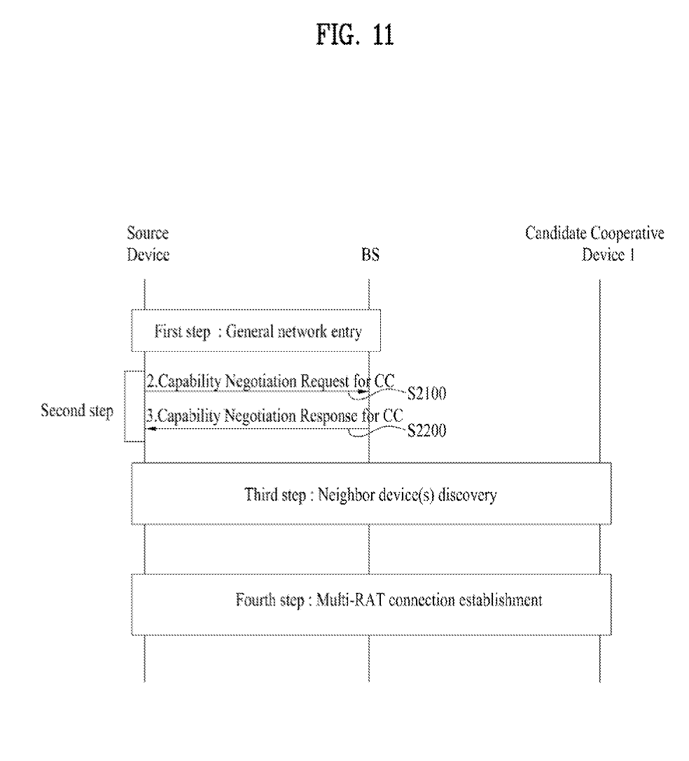

For convenience of description, the negotiation step S2000 will hereinafter be referred to as a second step. A detailed description of the second step will hereinafter be described with reference to FIGS. 11 to 14.

The BS, the source device, and a plurality of candidate cooperative devices upon completion of the second step enter the step S3000 for searching for the neighbor device and selecting the cooperative device from among the retrieved neighbor devices. For convenience of description and better understanding of the present invention, the step S3000 for searching for the neighbor device and selecting the cooperative device from among the retrieved neighbor devices will hereinafter be referred to as a third step.

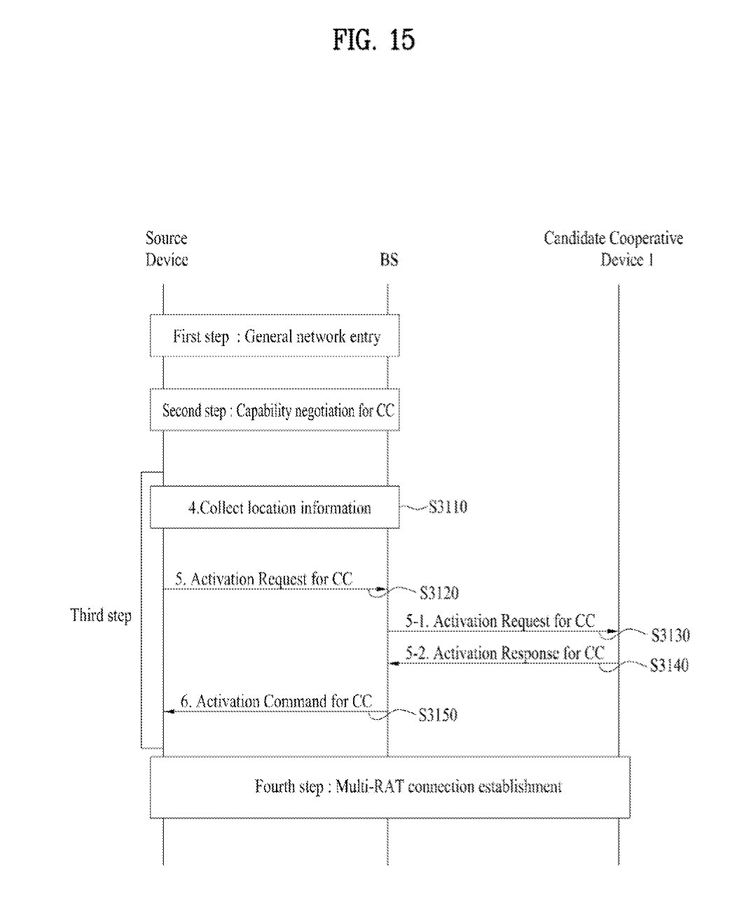

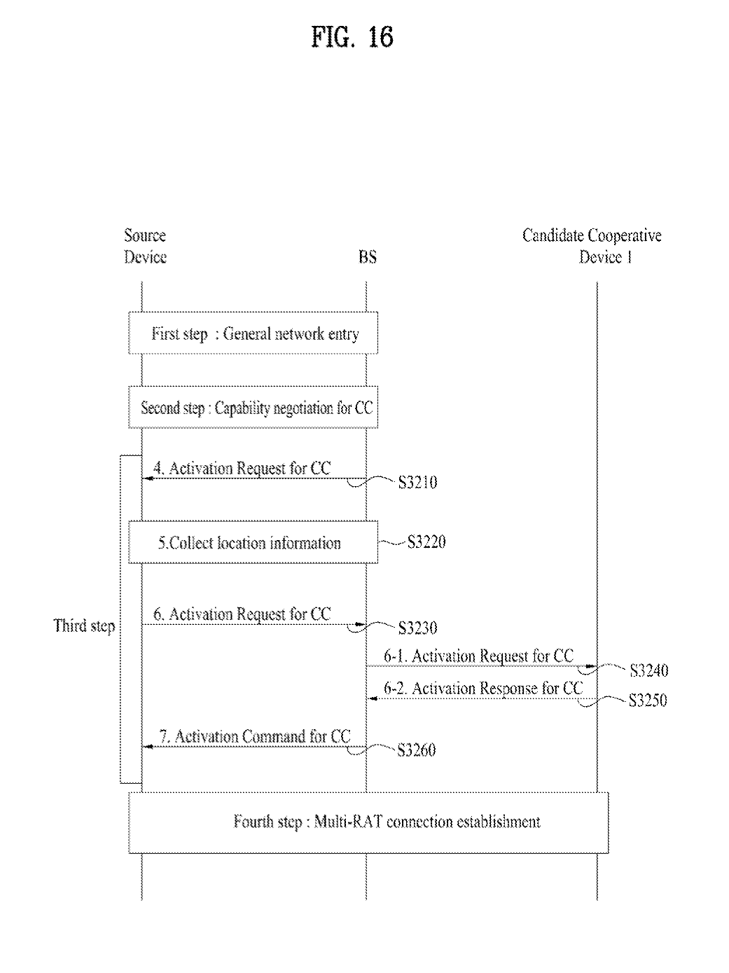

In the third step, the source device and several candidate cooperative devices exchange their location information with each other, and select a cooperative device to participate in data communication in the multi-RAT system on the basis of the exchanged information. A detailed description of the third step will hereinafter be described with reference to FIGS. 15 and 16.

The source device upon completion of the third step enters the step S4000 for connection to the selected cooperative device. If the step S4000 for connection to the selected cooperative device is completed, the connected source device and the cooperative device can transmit and receive data to and from the BS by cooperating with each other.

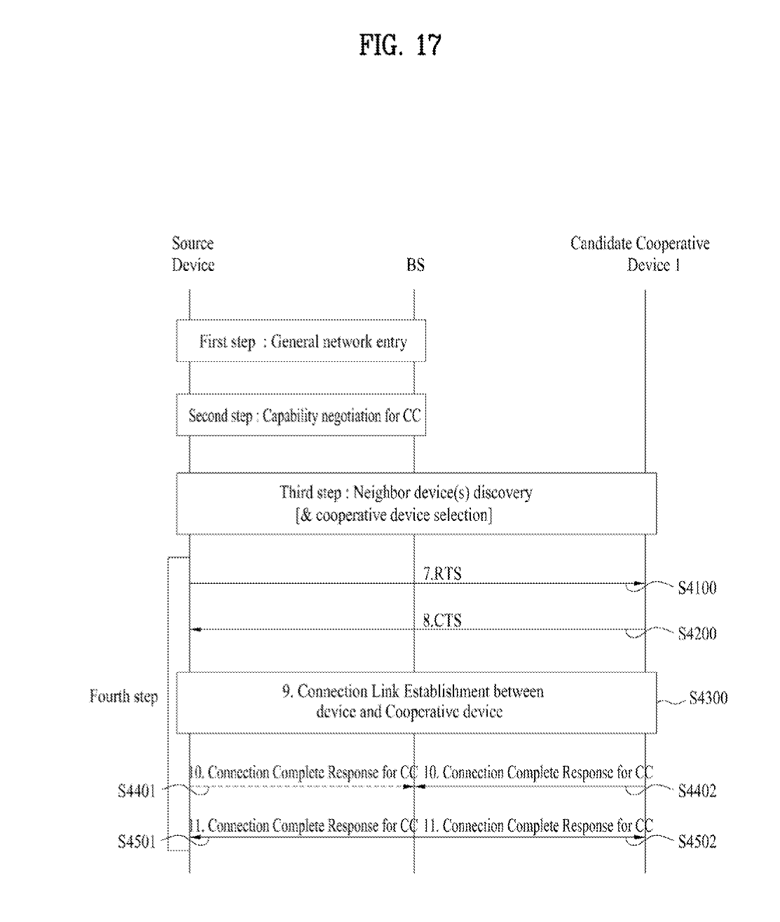

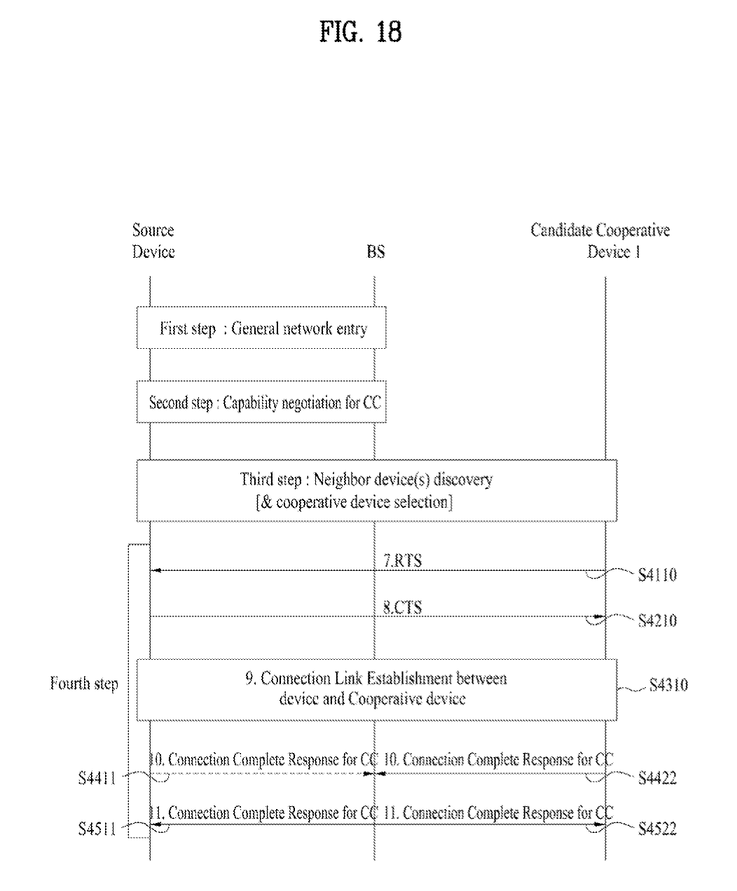

For convenience of description, the step S4000 for connection to the selected cooperative device will hereinafter be referred to as a fourth step. A detailed description of the fourth step will hereinafter be described with reference to FIGS. 17 and 18.

Individual steps of the information exchange procedure may not be commonly applied to all communication devices as necessary.

That is, the first step and the second step must be commonly carried out by a plurality of communication devices supporting the multi-RAT system. The third step and the four step may be carried out by at least one of the source device, the cooperative device and the candidate cooperative device, and not all communication devices need to perform the third step and the fourth step.

However, some steps (for example, steps for obtaining each location information of several communication devices supporting the multi-RAT system) to be described in the third step may be commonly carried out by all the communication devices.

Therefore, all the communication devices supporting the multi-RAT system must experience the first step and the second step, such that communication devices having experienced the first and second steps cannot be distinguished from each other. Upon completion of the third step, communication devices may be considered to be a preliminary source device and a preliminary cooperative device. Upon completion of the fourth step, the source device and the cooperative device cooperate with each other so that they can transmit and receive data to and from the BS.

Individual steps of the information exchange procedure will hereinafter be described in detail.

FIG. 10 is a flowchart illustrating a general network entry stage (i.e., first step) for use in a multi-RAT system according to an embodiment of the present invention.

The source device is connected to the BS through the first step S1100, the source device is connected to the BS so that it can directly transmit and receive data to and from the BS.

The source device can perform the first step S1100 according to the network entry scheme applied to IEEE 802.16 wireless communication technology or according to another network entry scheme applied to 3GPP wireless technology.

In the first step, the source device informs the BS of whether the source device serves as a cooperative device in the multi-RAT system.

In this case, information as to whether client cooperation is supported may be transmitted to the BS through any one of the MAC management message or the RRC management message exchanged in the legacy network entry process.

A method for performing the first step S1100 according to the network entry scheme in the 3GPP wireless technology will hereinafter be described in detail.

When powered on or when entering a new cell, a source device performs initial cell search. The initial cell search involves synchronization with a base station (BS). Specifically, the source device synchronizes with the BS and acquires a cell identifier (ID) and other information by receiving a Primary Synchronization CHannel (P-SCH) and a secondary synchronization channel (S-SCH) from the BS. Then the source device may acquire information broadcast in the cell by receiving a Physical Broadcast CHannel (PBCH) from the BS. During initial cell search, the source device may monitor downlink channel status by receiving a downlink reference signal (DL RS).

After initial cell search, the source device may acquire more specific system information by receiving a Physical Downlink Control Channel (PDCCH) and receiving a Physical Downlink Shared Channel (PDSCH) based on information of the PDCCH.

On the other hand, if the source device initially accesses the BS or if the source device does not have radio resources for signal transmission, it may perform a random access procedure to the BS. For random access, the source device may transmit a specific sequence as a preamble to the BS over a Physical Random Access Channel (PRACH) and receive a response message for the random access over a PDCCH and a PDSCH corresponding to the PDCCH. In the case of contention-based RACH other than the handover case, the source device may perform a contention resolution procedure by transmitting an additional PRACH and receiving a PDCCH and a PDSCH.

After the foregoing procedure, the source device may receive a PDCCH and a PDSCH and transmit a Physical Uplink Shared Channel (PUSCH) and a Physical Uplink Control Channel (PUCCH), as a general downlink/uplink (DL/UL) signal transmission procedure. Here, uplink control information transmitted from the source device to the BS or downlink control information transmitted from the source device to the BS may include a downlink (DL) or uplink (UL) Acknowledgement/Negative Acknowledgment (ACK/NACK) signal, a Channel Quality Indicator (CQI), a Precoding Matrix Index (PMI) and/or a Rank Indicator (RI). The source device adapted to operate in the 3GPP LTE system may transmit the control information such as CQI, PMI, and/or RI over the PUSCH and/or the PUCCH.

The second step will hereinafter be described with reference to FIG. 11.

FIG. 11 is a flowchart illustrating an exemplary negotiation stage (i.e., a second step) for cooperation of a plurality of devices in a multi-RAT system according to an embodiment of the present invention.

Referring to FIG. 11, the source device negotiates with the BS about capability for cooperation operations in the second step.

That is, as can be seen from FIG. 11, the source device transmits a capability negotiation request for Client Cooperation (CC) in the multi-RAT system to the BS in step S2100.

In response to the capability negotiation request, the BS transmits the capability negotiation response for Client Cooperation (CC) in the multi-RAT system to the source device in step S2200.

For convenience of description and better understanding of the present invention, the Client Cooperation operation in the multi-RAT system will hereinafter be referred to as a CC operation.

In the capability negotiation request step S2100 for CC and the capability negotiation response step S2200 for CC, information communicated between the BS and the source device may include connection RAT type information, system type information, system version information, location information, and information indicating whether the cooperative device role is executed.

For negotiation of the cooperative operation capability, the BS and the source device may exchange connection RAT type information with each other. The connection RAT type information may indicate connection RAT type information between the source device and the cooperative device. The connection RAT type information may be single RAT type information or multi-RAT type information.

The system type information may be exchanged when the connection RAT type information is multi-RAT system type information. The system type information indicates information of a system that is used or supported for connection between the source device and the cooperative device. For example, the system information may include information of WiFi or Bluetooth for use in IEEE 802.11a, IEEE 802.11b, IEEE 802.11g, and IEEE 802.11n technologies.

In addition, the system version information may be exchanged when the connection RAT type information is multi-RAT type information. The system version information indicates version information of a system that is used or supported for connection between the source device and the cooperative device.

In addition, the BS and the source device may exchange location information with each other to negotiate capability for the cooperative operation. The location information indicates specific information through which a current position of the source device can be recognized. The location information is not always contained in information communicated between the BS and the source device, and can also be contained only in the case where an activation request indication message indicating the presence of assistance of the cooperative device in the multi-RAT system is set to 1.

The process for enabling the source device to obtain location information may be carried out before execution of capability negotiation for CC including an activation request indicator of 1, before execution of the capability negotiation for CC, before transmission of a cooperative activation request, or after reception of a cooperative activation request from the BS. The source device may also inform the BS of accuracy of information transmitted along with location information. A detailed description thereof will hereinafter be described with reference to the attached drawings.

In addition, for negotiation for cooperative operation capability, the BS and the source device may exchange specific information indicating whether the cooperative device role can be executed.

However, the above-mentioned contents of information exchanged between the BS and the source device for negotiation of cooperative operation capability are disclosed only for illustrative purposes, and other information may also be exchanged between the BS and the source device.

On the other hand, the above-mentioned second step may be changed according to a transmission entity of the activation request indicator requesting assistance of the cooperative device in the multi-RAT system. That is, detailed contents of the second step may be changed according to a first case in which the source BS transmits the activation request indicator to the BS and a second case in which the BS transmits the activation request indicator to the source BS.

For convenience of description and better understanding of the present invention, the activation request indicator is determined according to whether the activation request is set to 1. That is, information including the activation request indicator of 1 indicates an activation request indicator.

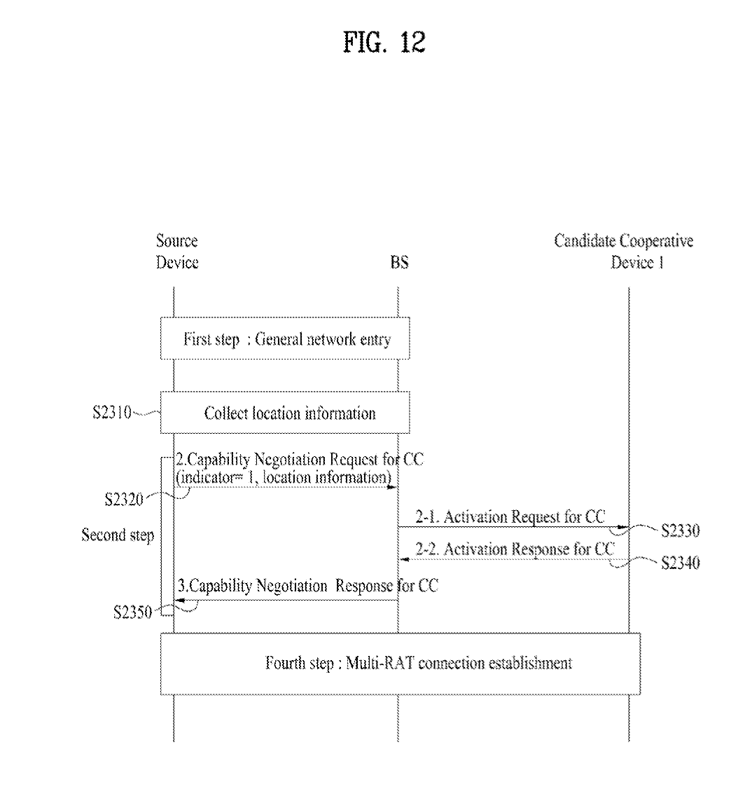

First, the second step in which the source BS transmits the activation request indicator to the BS will hereinafter be described with reference to FIG. 12.

That is, in the second step, when the cooperative device is determined and the connection establishment operation for the corresponding cooperative device is performed, the source device transmits the activation request indicator to the BS.

FIG. 12 is a flowchart illustrating an exemplary negotiation stage (i.e., the second step) required when a source device transmits information requesting assistance of a cooperative device in a multi-RAT system.

Referring to FIG. 12, the cooperative device is determined in the second step, and the BS must pre-collect location information of the source device before entering the second step so as to perform connection establishment for the corresponding cooperative device in step S2310.

Thereafter, the source device enters the second step such that the source device transmits the capability negotiation request for CC including the activation request indicator of 1 to the BS in step S2320.

If the BS receives the capability negotiation request for CC including the activation request indicator of 1 from the BS, the BS performs the same procedure as in reception of the activation request indication message.

That is, the cooperation activation request for CC is transmitted to the candidate cooperative devices on the basis of pre-collected location information of the source device in step S2330.

Thereafter, the BS receives the cooperative activation response for CC from the candidate cooperative devices in step S2340.

The BS having received the cooperative activation response for CC from the candidate cooperative devices does not immediately transmit the cooperative activation command to the source device, and simultaneously transmits the capability negotiation response for CC and information obtained through the step S2340 in step S2350. That is, the device transmits capability negotiation response for CC, a cooperation request result, multi-RAT type information (for example, MAC address) of the candidate cooperative devices, and information regarding a random access time (for example, a frame offset or number of frames) to the source device.

In the second step of FIG. 12, the cooperative device may be determined and the connection establishment operation for the corresponding cooperative device may also be immediately performed, such that the BS, the source device, and the candidate cooperative device are configured to perform the third step.

Thereafter, the source device and the selected cooperative device are connected to each other through the fourth step, and the cooperative relationship in the multi-RAT system is constructed. Thereafter, a detailed description of the fourth step will hereinafter be described with reference to FIGS. 17 and 18.

Meanwhile, the BS may transmit the activation request indicator to the source device.

That is, in the second step, if the BS desires to perform triggering for connection establishment for CC between communication devices in the multi-RAT system, the BS transmits the activation request indicator.

If the BS desires to transmit the activation request indicator to the source device, detailed contents of the second step may be changed according to a first case in which the BS recognizes location information of the source device and a second case in which the BS does not recognize location information of the source device.

If the BS recognizes the location information of the source device, the BS performs the same procedures as those of FIG. 12. That is, the second step is carried out in the same manner as in the case where the source BS transmits the activation request indicator to the BS.

On the other hand, if the activation request indicator is transmitted to the source device on the condition that the BS does not receive location information of the source device, the source device must perform the third step and the fourth step.

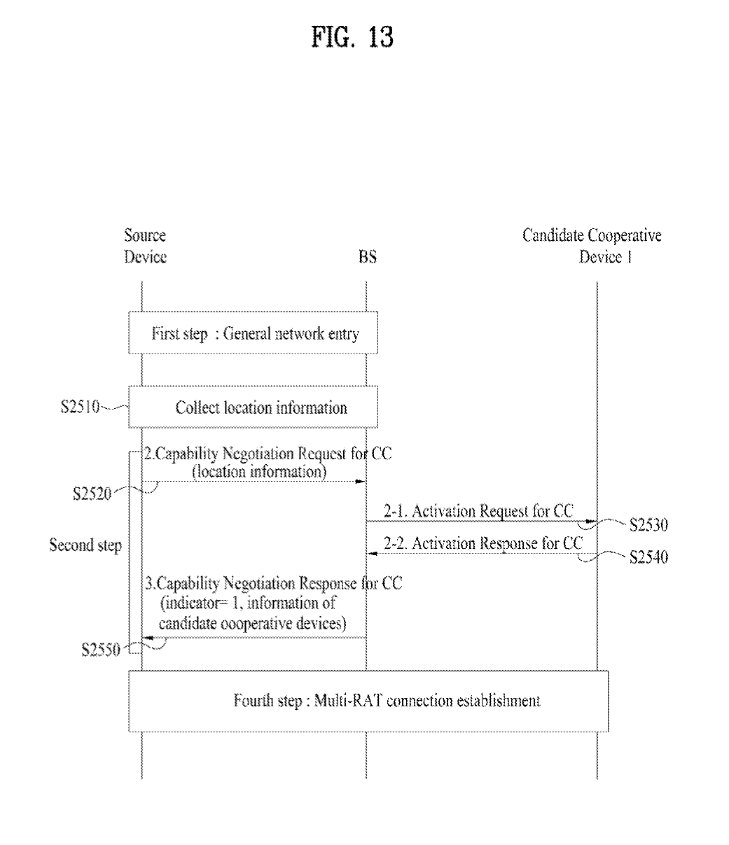

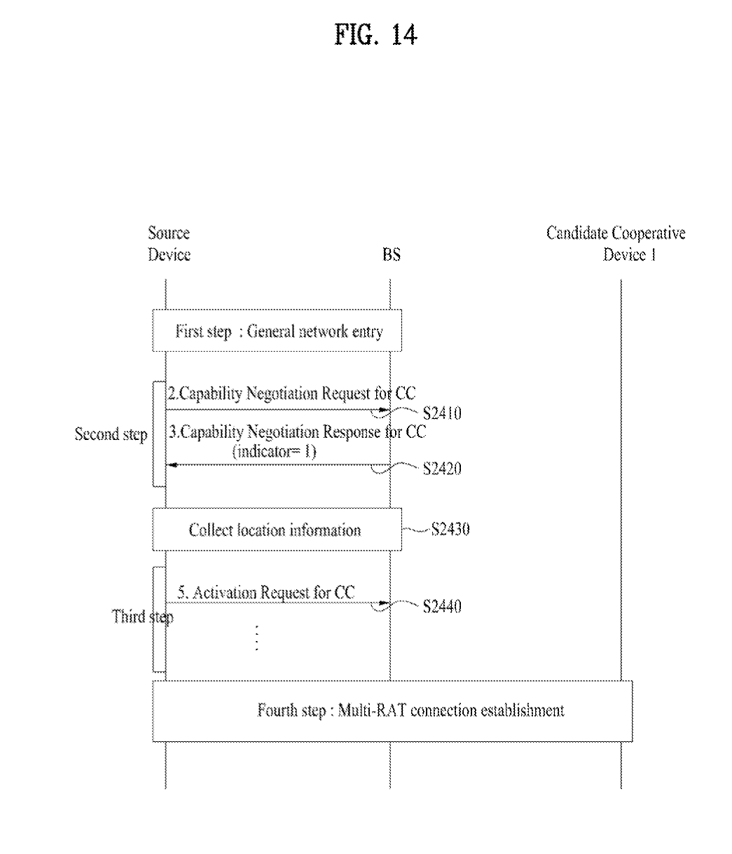

A detailed description thereof will hereinafter be described with reference to FIGS. 13 and 14.

FIG. 13 is a flowchart illustrating an exemplary negotiation stage required when a base station (BS) transmits information requesting assistance of a cooperative device in a multi-RAT system. FIG. 13 shows an exemplary case in which the BS has already recognized location information of the source device.

Referring to FIG. 13, the cooperative device is determined in the second step, and the BS must pre-collect location information of the source device before entering the second step so as to perform connection establishment for the corresponding cooperative device in step S2510.

Thereafter, the source device enters the second step, such that the source device transmits the capability negotiation request for CC including location information to the BS in step S2520.

The BS having received the capability negotiation request transmits the cooperative activation request for CC to the candidate cooperative devices on the basis of previously-received location information of the source device in step S2530.

Thereafter, the BS receives a cooperative negotiation response for CC from the candidate cooperative devices in step S2540.

The BS having received the cooperative activation response for CC from the candidate cooperative devices does not immediately transmit the cooperative activation command to the source device, and simultaneously transmits the capability negotiation response for CC, an activation request indicator of 1, and information obtained through the step S2540.

That is, the BS transmits capability negotiation response for CC, a cooperation request result along with the activation request indicator of 1, multi-RAT type information (for example, a MAC address) of the candidate cooperative devices, and information regarding a random access time (for example, a frame offset or number of frames) to the source device.

In the second step, the cooperative device may be determined and the connection establishment operation for the corresponding cooperative device may be performed, such that the BS, the source device, and the candidate cooperative device are configured to perform the third step.

Thereafter, the source device and the selected cooperative device are connected to each other through the fourth step, and the cooperative relationship in the multi-RAT system is constructed.

FIG. 14 is a flowchart illustrating another exemplary negotiation stage required when a base station (BS) transmits information requesting assistance of a cooperative device in a multi-RAT system. FIG. 14 shows an exemplary case in which the BS does not recognize location information of the source device.

Referring to FIG. 14, the source device transmits a capability negotiation request for CC in the multi-RAT system to the BS in step S2410.

In response to the capability negotiation request, the BS transmits the capability negotiation response for CC to the source device in step S2420. In this case, the BS may transmit the activation request indicator of 1 to the source device.

In this case, the BS does not recognize location information of the source device, such that it is impossible to perform the operation for immediately determining the cooperative device and performing connection establishment to the corresponding cooperative device in the second step. Therefore, the source device collects its own location information in step S2430, and enters the third step and the fourth step.

In the third step, the BS receives the cooperative activation request for CC from the source device in step S2440, and constructs the cooperation relationship in the multi-RAT system through the fourth step.

As described above, if the BS transmits the activation request indicator to the source device, detailed contents of the second step may be changed according to a first case in which the BS recognizes location information of the source device and a second case in which the BS does not recognize the location information of the source device.

A detailed description of the third step will be given below. In the third step, a neighbor device of the source device is searched for, and a cooperative device of the retrieved neighbor device is selected.

The third step may be changed according to a transmission entity of the cooperative activation request for CC. The cooperative activation request may be transmitted from the source device or the BS, and the third step may be changed according to a transmission entity (i.e., the source device or the BS) of the cooperative activation request.

After transmission of the activation request, the entity for attempting random access for cooperation in the multi-RAT system may be determined by the BS. In this case, the entity for attempting random access may be determined in consideration of accuracy of location information of the corresponding source device.

For example, assuming that correct location information is obtained, the source device may be the entity for attempting random access. If low-accuracy location information is obtained, the candidate cooperative device may be the entity for attempting random access.

If the entity for attempting random access is the candidate cooperative device, the BS transmits source device information in the CC activation negotiation process, and the candidate cooperative device may attempt to perform random access to the source device.

The third step may be classified into a first case in which the entity for transmitting the cooperative activation request is the source device and a second case in which the entity for transmitting the cooperative activation request is the BS.

The first case in which the entity for transmitting the cooperative activation request is the source device will hereinafter be described with reference to FIG. 15.

FIG. 15 is a flowchart illustrating the step (i.e., third step) for searching for a neighbor device of a source device and selecting a cooperative device from among retrieved neighbor devices.

Referring to FIG. 15, the source device collects its own location information in step S3110. The source device recognizes its own location using a GPS device or a location-based service based on a mobile communication network. In addition, accuracy of location information may be changed according to the scheme used for collecting location information.

For example, if location information is obtained through the GPS device, more accurate location information can be obtained.

As described above, the process S3110 for enabling the source device to collect location information may be carried out before execution of capability negotiation for CC including an activation request indicator of 1, before execution of the capability negotiation for CC, before transmission of a cooperative activation request, or after reception of a cooperative activation request from the BS.

After the source device collects location information, the source device transmits the cooperative activation request to the BS so as to communicate with the BS using the CC scheme in step S3120.

In this case, the source device can transmit the collected location information along with the cooperative activation request to the BS. In addition, the source device may also indicate accuracy of location information transmitted according to the scheme for collecting location information. For example, assuming that location information is obtained through the GPS device, the source device may also inform the BS of correct location information.

Upon receiving the cooperative activation request from the source device, the BS selects at least one candidate cooperative device adjacent to the source device on the basis of the received location information.

In this case, the BS may select the candidate cooperative device on the basis of either location information per sector or stepwise location information (for example, a neighbor region, a middle region, and a cell edge region) from the BS based on power control.

If the candidate cooperative device is selected, the BS transmits the cooperative activation request to the candidate cooperative devices in step S3130, and receives the cooperative activation response from the candidate cooperative device in step S3140.

In this case, the BS and the candidate cooperative devices discuss the RF activation time point of the multi-RAT system and specific information indicating whether the CC is supported.

Thereafter, the BS transmits the discussed result information to the source device through the activation command message for CC in step S3150.

In this case, the discussed result information applied to the source device may include result information of the cooperative activation request, multi-RAT system information (for example, MAC address, system type, system version, etc.) of the candidate cooperative devices, and random access time information (for example, frame offset, the number of frames, etc.).

In addition, according to whether multi-RAT system information of the candidate cooperative devices is contained in the activation command message, the source device may implicitly determine the entity for attempting random access or may explicitly determine the entity for attempting random access through information contained in the corresponding message.

The second case in which the entity for transmitting the cooperative activation request is the BS will hereinafter be described with reference to FIG. 16.

FIG. 16 is a flowchart illustrating another method for searching for a neighbor device of a source device and selecting a cooperative device from among retrieved neighbor devices.

Referring to FIG. 16, the BS transmits the cooperative activation request to the source device so as to communicate with the source device using the CC scheme in step S3210. That is, the BS may first request execution of the corresponding service from the source device so as to utilize the CC scheme, because a communication quality of the source device is deteriorated.

The source device having received the cooperative activation request from the BS can transmit the cooperative activation request and the source device location information to the BS in step S3230.

If the source device does not include its own latest location information, the process for collecting location information is carried out before the cooperative activation response is transmitted to the base station (BS) in step S3230.

The source device recognizes its own location using the GPS device or the location-based service based on a mobile communication network. In addition, accuracy of location information may be changed according to the scheme used for collecting location information.

In addition, the source device may also indicate accuracy of location information transmitted according to the scheme for collecting location information. For example, when location information is obtained through the GPS device, the source device may also inform the BS of correct location information.

The BS having received the cooperative activation response from the source device may select at least one candidate cooperative device adjacent to the source device on the basis of the received location information.

In this case, the BS may select the candidate cooperative device on the basis of either location information per sector or stepwise location information (for example, a neighbor region, a middle region, and a cell edge region) from the BS based on power control.

If the candidate cooperative device is selected, the BS transmits the cooperative activation request to the candidate cooperative devices in step S3240, and receives the cooperative activation response from the candidate cooperative device in step S3250.

In this case, the BS and the candidate cooperative devices discuss the RF activation time point of the multi-RAT system and specific information indicating whether the CC is supported.

Thereafter, the BS transmits the discussed result information to the source device through the activation command message for CC in step S3260.

In this case, the discussed result information applied to the source device may include result information of the cooperative activation request, multi-RAT system information (for example, MAC address, system type, system version, etc.) of the candidate cooperative devices, and random access time information (for example, frame offset, the number of frames, etc.).

In addition, according to whether multi-RAT system information of the candidate cooperative devices is contained in the activation command message, the source device may implicitly determine the entity for attempting random access or may explicitly determine the entity for attempting random access through information contained in the corresponding message.

The fourth step in which the source device is connected to the selected cooperative device will hereinafter be described in detail.

As described above, the entity for attempting random access may be determined in consideration of accuracy of location information of the source device. For example, assuming that correct location information is obtained, the source device may be the entity for attempting random access. Assuming that low-accuracy location information is obtained, the candidate cooperative device may be the entity for attempting random access.

The fourth step may be changed according to a first case in which the entity for attempting random access is the source device and the second case in which the entity for attempting random access is the candidate cooperative device.

A detailed description thereof will hereinafter be described with reference to FIGS. 17 and 18.

FIG. 17 is a flowchart illustrating a detailed process of the fourth step when the entity for attempting random access is the source device.

That is, it is assumed that the entity for attempting random access in the multi-RAT system is explicitly or implicitly determined to be the source device in the third step.

Referring to FIG. 17, the source device transmits information (for example, RTS) for attempting random access according to each candidate cooperative device and the corresponding system on the basis of the candidate cooperative device information received from the BS in step S4100.

In this case, in order to prevent the contention problem caused by random access attempt, the source device may attempt random access at a random access time point contained in information received from the BS.

Thereafter, the candidate cooperative devices capable of performing random access may transmit a response (for example, CTS) to the random access attempt to the source device in step S4200.

If the source device receives a response to the random access attempt, the source device performs CC connection to the candidate cooperative device that has generated the response in step S4300.

If the CC connection operation is completed, the cooperative device informs the BS of the connection establishment result for the source device in step S4402.

In this case, the result report of the connection establishment may also be carried out by the source device instead of the cooperative device in step S4401.

If the BS receives the connection establishment result from the source device or the cooperative device, addressing information (for example, a logic ID used only for the CC operation or a logic ID of the source device) and security information that are required for the CC operation are transmitted to the source device and the cooperative device in steps S4501 and S4502.

If the BS receives the connection establishment result from several cooperative devices, the BS may select only one of several cooperative devices, and may inform the remaining cooperative devices of information regarding the selected one cooperative device.

FIG. 18 is a flowchart illustrating a detailed process of the fourth step when the entity for attempting random access is the candidate cooperative device.

That is, as can be seen from FIG. 18, it is assumed that the entity for attempting random access in the multi-RAT system is explicitly or implicitly determined to be the candidate cooperative device in the third step.

Referring to FIG. 18, the candidate cooperative device transmits information (for example, RTS) for attempting random access according to the source device and the corresponding system on the basis of the source device information received from the BS in step S4110.

In this case, in order to prevent the contention problem caused by random access attempt, the candidate cooperative device may attempt random access at a random access time point contained in information received from the BS.

Thereafter, the source device may transmit a response (for example, CTS) to the random access attempt to the candidate cooperative device in step S4210.

If the candidate cooperative device receives a response to the random access attempt, it performs CC connection to the source device in step S4310.

If the CC connection operation is completed, the cooperative device informs the BS of the connection establishment result for the source device in step S4422.

In this case, the result report of the connection establishment may also be carried out by the source device instead of the cooperative device in step S4411.

If the BS receives the connection establishment result from the source device or the cooperative device, addressing information (for example, a logic ID used only for the CC operation or a logic ID of the source device) and security information that are required for the CC operation are transmitted to the source device and the cooperative device in steps S4511 and S4522.

If the BS receives the connection establishment result from several cooperative devices, the BS may select only one of several cooperative devices, and may inform the remaining cooperative devices of information regarding the selected one cooperative device.

If the first to fourth steps are completed (if necessary, the third step may be omitted as described above), the cooperation system between the source device and the cooperative device is constructed in the multi-RAT system. Thereafter, the source device may transmit data along with the cooperative device having a high communication quality, or may transmit data through the cooperative device having a superior communication quality without participating in data transmission, such that data communication can be carried out by cooperating with the BS.

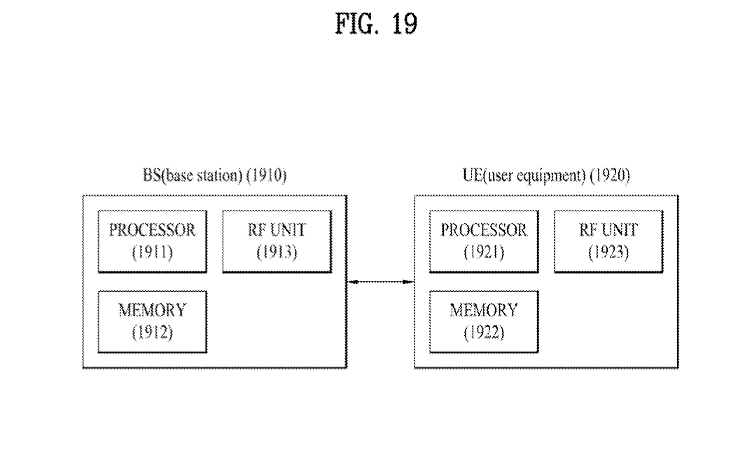

FIG. 19 is a block diagram illustrating a base station (BS) apparatus 1910 and a communication device 1920 supporting the multi-RAT system according to embodiments of the present invention. Although the term “UE” may be used interchangeably with the terms “communication device” and “communication apparatus” in the above-mentioned description, it should be noted that the above terms will hereinafter be referred to as “UE apparatus” only for convenience of description and better understanding of the present invention.

Referring to FIG. 19, the BS apparatus 1910 according to the present invention may include a reception (Rx) module 1911, a transmission (Tx) module 1912, a processor 1913, a memory 1914, and a plurality of antennas 1915. The plurality of antennas 1915 indicates a BS apparatus for supporting MIMO transmission and reception. The reception (Rx) module 1911 may receive a variety of signals, data and information on an uplink starting from the UE. The Tx module 1912 may transmit a variety of signals, data and information on a downlink for the UE. The processor 1913 may provide overall control to the BS apparatus 1910.

The processor 1913 of the BS apparatus 1910 is configured to perform a first step, a second step, a third step, and a fourth step. In the first step, several UE apparatus for use in the multi-RAT system construct the cooperative relationship, and a general network entry step for data communication with the BS is achieved. In the second step, several devices perform the negotiation process for cooperation. In the third step, a neighbor device of the source device is searched for, and a cooperative device from among the retrieved neighbor devices is selected. In the fourth step, connection to the selected cooperative device is achieved.

The processor 1913 of the BS apparatus 1910 processes information received at the BS apparatus 1910 and transmission information to be transmitted externally. The memory 1914 may store the processed information for a predetermined time. The memory 1914 may be replaced with a component such as a buffer (not shown).

Referring to FIG. 19, the UE apparatus 1920 may include an Rx module 1921, a Tx module 1922, a processor 1923, a memory 1924, and a plurality of antennas 1925. The plurality of antennas 1925 indicates a UE apparatus for supporting MIMO transmission and reception. The Rx module 1921 may receive downlink signals, data and information from the BS. The Tx module 1922 may transmit uplink signals, data and information to the BS. The processor 1923 may provide overall control to the UE apparatus 1920.

The processor 1923 of the UE apparatus 1920 is configured to perform a first step, a second step, a third step, and a fourth step. In the first step, several UE apparatus for use in the multi-RAT system construct the cooperative relationship, and a general network entry step for data communication with the BS is achieved. In the second step, several devices perform the negotiation process for cooperation. In the third step, a neighbor device of the source device is searched for, and a cooperative device from among the retrieved neighbor devices is selected. In the fourth step, connection to the selected cooperative device is achieved.

The specific configurations of the BS apparatus and the UE apparatus may be implemented such that the various embodiments of the present invention are performed independently or two or more embodiments of the present invention are performed simultaneously. Redundant matters will not be described herein for clarity.

The description of the BS apparatus 1910 shown in FIG. 19 may also be applied to a relay node (RN) acting as a DL transmission entity or UL reception entity without departing from the scope or spirit of the present invention. In addition, the description of the UE apparatus 1920 may also be applied to a relay node (RN) acting as a UL transmission entity or DL reception entity without departing from the scope or spirit of the present invention.

The above-described embodiments of the present invention can be implemented by a variety of means, for example, hardware, firmware, software, or a combination thereof.

In the case of implementing the present invention by hardware, the present invention can be implemented with application specific integrated circuits (ASICs), Digital signal processors (DSPs), digital signal processing devices (DSPDs), programmable logic devices (PLDs), field programmable gate arrays (FPGAs), a processor, a controller, a microcontroller, a microprocessor, etc.

If operations or functions of the present invention are implemented by firmware or software, the present invention can be implemented in the form of a variety of formats, for example, modules, procedures, functions, etc. The software codes may be stored in a memory to be driven by a processor. The memory is located inside or outside of the processor, so that it can communicate with the aforementioned processor via a variety of well-known parts.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may use each construction described in the above embodiments in combination with each other. Accordingly, the invention should not be limited to the specific embodiments described herein, but should be accorded the broadest scope consistent with the principles and novel features disclosed herein.

Those skilled in the art will appreciate that the present invention may be carried out in other specific ways than those set forth herein without departing from the spirit and essential characteristics of the present invention. The above exemplary embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. Also, it will be obvious to those skilled in the art that claims that are not explicitly cited in the appended claims may be presented in combination as an exemplary embodiment of the present invention or included as a new claim by subsequent amendment after the application is filed.

### INDUSTRIAL APPLICABILITY

The embodiments of the present invention can be applied to a multi-RAT system and a wireless communication system. In more detail, the embodiments of the present invention can also be applied to a wireless mobile communication device for a cellular system.

1. A method for performing communication by a user equipment (UE) supporting a multi-RAT (Multi-Radio Access Technology), the method comprising:
transmitting a capability negotiation request message for a client cooperation (CC) to a base station (BS);
receiving a capability negotiation response message for the CC from the base station (BS);
receiving an activation command message for the CC including information regarding at least one candidate cooperative device from the base station (BS);
transmitting a connection message for the CC to the at least one candidate cooperative device using information regarding the at least one candidate cooperative device; and
transmitting a first data to the base station (BS) using at least one cooperative device connected through the connection message from among the at least one candidate cooperative device,
wherein the first data is communicated between the UE and the at least one cooperative device using a first radio access scheme, and is communicated between the at least one cooperative device and the base station (BS) using a second radio access scheme.

2. The method according to claim 1, further comprising:
directly transmitting a second data to the base station (BS) using the second radio access scheme.

3. The method according to claim 1, wherein the first radio access scheme is a Wireless Fidelity (WiFi) access scheme, and the second radio access scheme is a Worldwide Interoperability for Microwave Access (WiMAX) access scheme.

4. The method according to claim 1, wherein the capability negotiation request message includes a request for at least one of connection RAT type information, system type information, system version information, location information, and information regarding availability of role performance of the cooperative device by the UE.

5. The method according to claim 1, further comprising:
after receiving the capability negotiation response message, transmitting a first activation request message for the CC including location information of the UE to the base station (BS); and
receiving the activation command message from the base station (BS) in response to the first activation request message.

6. The method according to claim 1, further comprising:
after receiving the capability negotiation response message, receiving a first activation request message for the CC from the base station (BS);
transmitting a first activation response message for the CC including location information of the UE to the base station (BS), and
wherein the activation command message is received from the base station (BS) in response to the first activation response message.

7. A method for to performing communication by a base station (BS) supporting a multi-RAT (Multi-Radio Access Technology), the method comprising:
receiving a capability negotiation request message for a client cooperation (CC) from a user equipment (UE);
transmitting a capability negotiation response message for the CC to the user equipment (UE);
transmitting an activation command message for the CC including information regarding at least one candidate cooperative device to the user equipment (UE); and
receiving a first data using at least one cooperative device connected to the UE through a connection message for the CC from among the at least one candidate cooperative device,
wherein the first data is communicated between the UE and the at least one cooperative device using a first radio access scheme, and is communicated between the at least one cooperative device and the base station (BS) using a second radio access scheme.

8. The method according to claim 7, further comprising:
directly receiving a second data from the user equipment (UE) using the second radio access scheme.

9. The method according to claim 7, wherein the first radio access scheme is a Wireless Fidelity (WiFi) access scheme, and the second radio access scheme is a Worldwide Interoperability for Microwave Access (WiMAX) access scheme.

10. The method according to claim 7, wherein the capability negotiation request message includes a request for at least one of connection RAT type information, system type information, system version information, location information, and information regarding availability of role performance of the cooperative device by the UE.

11. The method according to claim 7, further comprising:
after transmitting the capability negotiation response message, receiving a first activation request message for the CC including location information of the UE from the UE;
transmitting a second activation request message for the CC to the at least one candidate cooperative device using the location information of the UE; and
receiving a second activation response message for the CC from the at least one candidate cooperative device,
wherein the activation command message is transmitted to the UE using the received second activation response message.

12. The method according to claim 7, further comprising:
after transmitting the capability negotiation response message, transmitting a first activation request message for the CC to the UE;
receiving a first activation response message for the CC including location information of the UE from the UE;
transmitting a second activation request message for the CC to the at least one candidate cooperative device using the location information of the UE; and
receiving a second activation response message for the CC from the at least one candidate cooperative device,
wherein the activation command message is transmitted to the UE using the received second activation response message.

13. A method for performing communication by a user equipment (UE) supporting a multi-RAT (Multi-Radio Access Technology), the method comprising:
transmitting a capability negotiation request message for a client cooperation (CC) to a base station (BS), the capability negotiation request message including location information of the UE and an activation request indicator for the CC;
receiving a capability negotiation response message for the CC including information regarding at least one candidate cooperative device from the base station (BS);
transmitting a connection message for the CC to the at least one candidate cooperative device using information regarding the at least one candidate cooperative device; and
transmitting a first data to the base station (BS) using at least one cooperative device connected through the connection message from among the at least one candidate cooperative device,
wherein the first data is communicated between the UE and the at least one cooperative device using a first radio access scheme, and is communicated between the at least one cooperative device and the base station (BS) using a second radio access scheme.

14. A method for performing communication by a base station (BS) supporting a multi-RAT (Multi-Radio Access Technology), the method comprising:
receiving a capability negotiation request message for a client cooperation (CC) from a user equipment (UE), the capability negotiation request message including location information of the UE and an activation request indicator for the CC;
transmitting a second activation request message for the CC to the at least one candidate cooperative device using the location information of the UE;
receiving a second activation response message for the CC from the at least one candidate cooperative device;
transmitting a capability negotiation response message for the CC including information of the at least one candidate cooperative device to the UE using the received second activation response message;
receiving a first data using at least one cooperative device connected to the UE through the connection message for the CC from among the at least one candidate cooperative device,
wherein the first data is communicated between the UE and the at least one cooperative device using a first radio access scheme, and is communicated between the at least one cooperative device and the base station (BS) using a second radio access scheme.

15. A method for performing communication by a user equipment (UE) supporting a multi-RAT (Multi-Radio Access Technology), the method comprising:
transmitting a capability negotiation request message for a client cooperation (CC) including location information of the UE to a base station (BS);
receiving a capability negotiation response message for the CC from the base station (BS), the capability negotiation response message including an activation request indicator for the CC and information regarding at least one candidate cooperative device;
transmitting a connection message for the CC to the at least one candidate cooperative device using information regarding the at least one candidate cooperative device; and
transmitting a first data to the base station (BS) using at least one cooperative device connected through the connection message from among the at least one candidate cooperative device,
wherein the first data is communicated between the UE and the at least one cooperative device using a first radio access scheme, and is communicated between the at least one cooperative device and the base station (BS) using a second radio access scheme.

16. A method for performing communication by a base station (BS) supporting a multi-RAT (Multi-Radio Access Technology), the method comprising:
receiving a capability negotiation request message for a client cooperation (CC) including location information of a user equipment (UE) from the UE;
transmitting a second activation request message for the CC to the at least one candidate cooperative device using the location information of the UE;
receiving a second activation response message for the CC from the at least one candidate cooperative device;
transmitting a capability negotiation response message for the CC, including information of the at least one candidate cooperative device and an activation request indicator for the CC, to the UE using the received second activation response message; and
receiving a first data using at least one cooperative device connected to the UE through the connection message for the CC from among the at least one candidate cooperative device,
wherein the first data is communicated between the UE and the at least one cooperative device using a first radio access scheme, and is communicated between the at least one cooperative device and the base station (BS) using a second radio access scheme.

17. A user equipment (UE) for supporting a multi-RAT (Multi-Radio Access Technology) comprising:
a transmission (Tx) module for transmitting a capability negotiation request message for a client cooperation (CC) to a base station (BS), and transmitting a connection message for the CC to the at least one candidate cooperative device using information regarding the at least one candidate cooperative device;
a reception (Rx) module for receiving a capability negotiation response message for the CC from the base station (BS), and receiving an activation command message for the CC including information regarding the at least one candidate cooperative device from the base station (BS); and
a processor for transmitting a first data to the base station (BS) using at least one cooperative device connected through the connection message from among the at least one candidate cooperative device, controlling the first data to be communicated between the UE and the at least one cooperative device using a first radio access scheme and controlling the first data to be communicated between the at least one cooperative device and the base station (BS) using a second radio access scheme.

18. A base station (BS) for supporting a multi-RAT (Multi-Radio Access Technology) comprising:
a reception (Rx) module for receiving a capability negotiation request message for a client cooperation (CC) from a user equipment (UE), and receiving a first data using at least one cooperative device connected to the UE through the connection message for the CC from among the at least one candidate cooperative device;
a transmission (Tx) module for transmitting a capability negotiation response message for the CC to the UE, and transmitting an activation command message for the CC including information regarding the at least one candidate cooperative device to the UE; and
a processor for controlling the first data to be communicated between the UE and the at least one cooperative device using a first radio access scheme, and controlling the first data to be communicated between the at least one cooperative device and the base station (BS) using a second radio access scheme.

19. A user equipment (UE) for supporting a multi-RAT (Multi-Radio Access Technology) comprising:
a transmission (Tx) module for transmitting a capability negotiation request message for a client cooperation (CC) to a base station (BS), the capability negotiation request message including location information of the UE and an activation request indicator for the CC, and transmitting a connection message for the CC to the at least one candidate cooperative device using information regarding the at least one candidate cooperative device;
a reception (RX) module for receiving a capability negotiation response message for the CC including information regarding the at least one candidate cooperative device from the base station (BS); and
a processor for transmitting a first data to the base station (BS) using at least one cooperative device connected through the connection message from among the at least one candidate cooperative device, controlling the first data to be communicated between the UE and the at least one cooperative device using a first radio access scheme and controlling the first data to be communicated between the at least one cooperative device and the base station (BS) using a second radio access scheme.

20. A user equipment (UE) for supporting a multi-RAT (Multi-Radio Access Technology) comprising:
a transmission (Tx) module for transmitting a capability negotiation request message for a client cooperation (CC) including location information of the UE to a base station (BS), and transmitting a connection message for the CC to the at least one candidate cooperative device using information regarding the at least one candidate cooperative device;
a reception (Rx) module for receiving a capability negotiation response message for the CC from the base station (BS), the capability negotiation response message including an activation request indicator for the CC and information regarding the at least one candidate cooperative device; and
a processor for transmitting a first data to the base station (BS) using at least one cooperative device connected through the connection message from among the at least one candidate cooperative device, controlling the first data to be communicated between the UE and the at least one cooperative device using a first radio access scheme and to be communicated between the at least one cooperative device and the base station (BS) using a second radio access scheme.
